(19) United States
(12) Patent Application Publication
(10) Pub. No.: US 2006/0001567 A1
(43) Pub. Date: Jan. 5, 2006

(54) Sensor with improved voltage protection

(76) Inventor: Valter Nilsson, Hovas (SE)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(21) Appl. No.: 10/883,567

(22) Filed: Jul. 1, 2004

(51) Int. Cl. G01S 13/08

(52) U.S. Cl. 342/124; 342/198

(57) ABSTRACT

A radar level gauge using microwaves for measuring a level of a surface of a product in a container, comprising a two-wire interface for connecting said measurement circuitry externally of said radar level gauge. A voltage protection circuitry connected between the two lines of the two-wire interface, the voltage protection circuitry including a transistor having an input, an output and a control terminal, a voltage regulator component connected between the output and the control terminal in such a way that the regulating characteristics of the voltage regulator component determines the voltage required to open the transistor, and a resistor connected between the control terminal and the input of the transistor.

### FIELD OF THE INVENTION

The present invention relates to a voltage protected sensor for gauging a process variable, and more specifically a radar level gauge with a voltage protection circuit.

### BACKGROUND OF THE INVENTION

Radar level gauges for measuring of a level in a tank, and other types of process sensors, are typically connected with a two-wire interface, where only two lines serve to both supply the sensor with power and to communicate a measured and processed measuring signal. The interface can be a 4-20 mA industrial loop. Other possible interfaces include a four-wire interface, where two lines provide power, and two wires communicate measurement signals.

In the case where measurements are made in a tank containing explosive gas or liquids, or in any other situation where the sensor is located in an explosion endangered area, special protection is required. Normally, either the installation is made explosion proof by some kind of casement, or its outside electrical connection is made intrinsically safe. The latter case requires that input power, voltage and current do not exceed levels stated by safety regulations. This is ensured by a so called electrical barrier, arranged in the interface to the intrinsically safe area.

Such a barrier can comprise fuses on each line for protection against excessive input power/current, and at least one voltage protection circuit, here referred to as a voltage shunt, connected between the two lines for protection against excessive voltages. The voltage shunt is typically based on one or several zener diodes. Further, resistors are typically connected on each line, to protect the area against excessive output power/current.

In addition to the safety aspect, the barrier should have little or no impact on the normal function of the sensor equipment. It is therefore important to reduce any current through the voltage shunt, as such current consumption would disturb the power supply and the reliability of the sensor signal.

For this purpose, a series voltage regulator is normally arranged prior to the electrical barrier in order to ensure that the voltage over the shunt during operation is smaller than the threshold voltage, thus avoiding any current through the diode. The series voltage regulator enables the sensor to handle a greater input voltage range.

The operation output voltage from the preceding regulator is preferably as close to the limiting threshold voltage of the shunt as possible, in order to provide the sensor electronics with the required power. However, the voltage regulation characteristics of the diode can make a safety margin necessary, thus reducing the maximum operation voltage from the regulator.

### SUMMARY OF THE INVENTION

A first aspect of the invention relates to a radar level gauge using microwaves for measuring a level of a surface of a product in a container, comprising a microwave emitter for transmitting microwaves towards the surface and receiving microwaves reflected by the surface, measurement circuitry arranged to determine said level based on a relation between transmitted and received microwaves, a signal transfer medium coupled at a first end to said microwave emitter and coupled at second end to said measurement circuitry, a two-wire interface for connecting said measurement circuitry externally of said radar level gauge, and voltage protection circuitry connected between the two lines of the two-wire interface. The voltage protection circuitry includes a transistor having an input, an output and a control terminal, a voltage regulator component connected between the output and the control terminal in such a way that the regulating characteristics of the voltage regulator component determines the voltage required to open the transistor, and a resistor connected between the control terminal and the input of the transistor.

This aspect of the invention can more generally be directed to any sensor for gauging a process variable having a two-wire interface provided with such a voltage protection circuit.

In such a voltage protection circuit, almost all power is dissipated in the transistor (preferably a power transistor), enabling the use of a low power voltage regulating diode. A low power diode, for example a zener diode, can be chosen to have accurate voltage regulation at very low currents. This characteristics will then decide the characteristics of the entire circuit, providing a high power protection circuit with improved characteristics.

Also, transistor components are generally more suitable for dissipating higher amount of energy.

In case the transistor is a field effect transistor (e.g. a MOSFET), the control terminal is the gate, the output is the drain and the input is the source. In case the transistor is a bipolar transistor, the control terminal is the base, the output is the collector, and the input is the emitter.

A second aspect of the invention relates to a radar level gauge using microwaves for measuring a level of a surface of a product in a container, comprising a microwave emitter for transmitting microwaves towards the surface and receiving microwaves reflected by the surface, measurement circuitry arranged to determine said level based on a relation between transmitted and received microwaves, a signal transfer medium coupled at a first end to said microwave emitter and coupled at second end to said measurement circuitry, a two-wire interface for connecting said measurement circuitry externally of said radar level gauge, and voltage protection circuitry connected between the two lines of the two-wire interface. The voltage protection circuitry includes a voltage regulator device having a cathode and an anode, a first diode connected with its anode to the first line and its cathode to the cathode of the regulator device, a second diode connected with its cathode to the second line and its anode to the anode of the regulator device, a third diode connected with its cathode to the cathode of the first diode and its anode to ground, a fourth diode connected with its anode to the anode of the second diode and its cathode to ground.

This aspect of the invention can more generally be directed to any sensor for gauging a process variable having a two-wire interface provided with such a voltage protection circuitry.

By selecting the components appropriately, such a voltage protection circuit can be made symmetrical with respect to the ground connection. Such a circuit will allow connection to a power supply independent of its ground connection, e.g. with positive ground connection as well as negative.

The voltage regulator component can be embodied by a voltage protection circuit according to the first embodiment of the invention, but this is not a requirement. On the contrary, the voltage protection circuit according to the second aspect of the invention by itself represents significant advantages over prior art.

A third aspect of the invention relates to radar level gauge using microwaves for measuring a level of a surface of a product in a container, comprising a microwave emitter for transmitting microwaves towards the surface and receiving microwaves reflected by the surface, measurement circuitry arranged to determine said level based on a relation between transmitted and received microwaves, a signal transfer medium coupled at a first end to said microwave emitter and coupled at second end to said measurement circuitry, a two-wire interface for connecting said measurement circuitry externally of said radar level gauge. The gauge further comprises voltage protection circuitry connected between the two lines of the two-wire interface, said voltage protection circuit being symmetric with respect to ground, a first current controlled voltage regulator connected on the first line, and a second current controlled voltage regulator connected on the second line, said voltage regulators being controlled by a regulating current flowing through the voltage barrier.

This aspect of the invention can more generally be directed to any sensor for gauging a process variable having a two-wire interface provided with such a voltage protection circuitry and voltage regulators.

By dividing the voltage regulation preceding the voltage shunt on the two lines, the symmetry of the circuit can be ensured. As the regulators are both controlled by a small regulating threshold current through the voltage protection circuit, they will enable adjustment of the voltage drop over each line in order to reduce current consumption to ground due to differences in ground potential between the communication interface and the power supply.

The circuit configuration may include a symmetric voltage protection circuit according to the second aspect of the invention, but this is not a requirement. On the contrary, the regulator configuration according to the third aspect of the invention by itself represents significant advantages over prior art.

### BRIEF DESCRIPTION OF THE DRAWINGS

These and other aspects of the present invention will be further described with reference to the appended drawings, illustrating presently preferred embodiements.

FIG. 1 is a block diagram of a radar level gauge system including a two-wire interface provided with an electrical barrier.

FIG. 2a is a block diagram of a voltage protection circuit according to a first embodiment of the invention.

FIG. 2b is a block diagram of a voltage protection circuit according to a second embodiment of the invention.

FIG. 3 is a block diagram of a voltage protection circuit according to a third embodiment of the invention.

FIG. 4 is a block diagram of a voltage protection circuit according to a fourth embodiment of the invention.

FIG. 5 is a block diagram of a sensor provided with a voltage protection circuit according to a fifth embodiment of the invention.

FIG. 6 is a more detailed circuit diagram of a voltage regulator in FIG. 5.

### DETAILED DESCRIPTION OF PREFERRED EMBODIMENTS

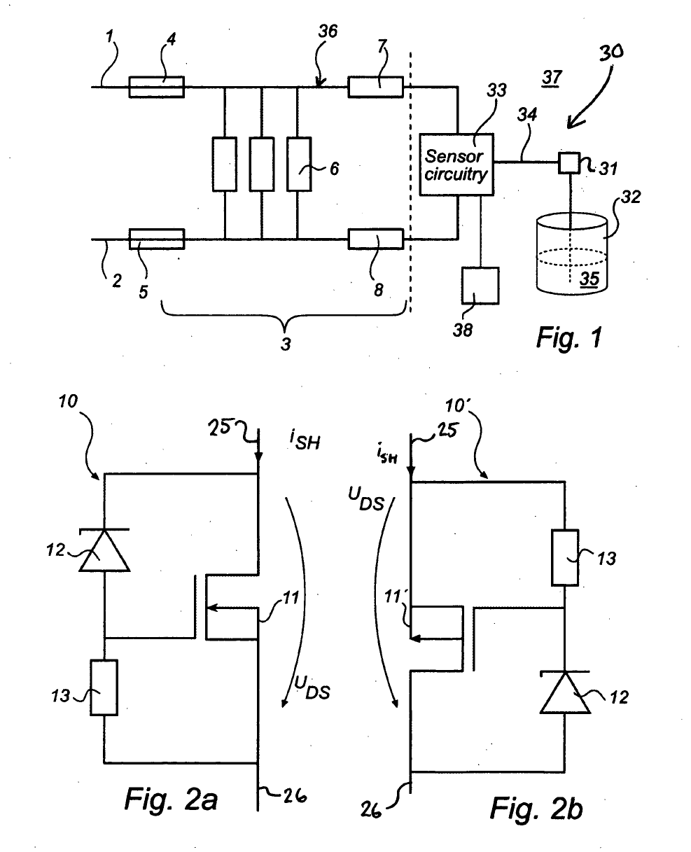

FIG. 1 shows an example of a radar level gauge system 30, including a microwave emitter 31 extending into a tank 32, a measurement circuitry 33, and a signal transfer medium 34 connecting the emitter 31 to the circuitry 33. The microwave emitter 31 is arranged to act as an adapter, transmitting microwaves into the tank 32 to be reflected by a surface of a material 35 in the tank. The microwaves can be guided into the tank by a probe, as shown in FIG. 1, or the emitter can be a free radiating antenna in the top of the tank. The reflected waves are fed by the signal transfer medium 34 back to the circuitry 33, and a measurement result based on this signal is determined. The result typically represents a level indication of the material 35. The signal transfer medium 34 can comprise a wire or cable transmitting a pulse signal from the circuitry 33, as well as a wave guide connecting to the emitter 31. It is also possible that the circuitry 33 is connected directly to the emitter 31 with a suitable terminal, which then constitutes the transfer medium 34, or that the emitter is arranged on the same circuit board as the circuitry 33, in which the transfer medium 34 can be a conducting path on this circuit board.

The circuitry 33 is further connected to a two-wire interface 36, comprising two lines 1, 2, and an electrical barrier 3. The barrier ensures that the area 37, in which the gauge system is installed, is intrinsically safe, i.e. that power, current and voltage are kept below given limits, reducing the risk of hazard.

The interface 36 is typically arranged to provide power to the measurement circuitry 33, and possibly also to communicate a measurement result from the circuitry 33. An example of such a two-wire connection, at the same time providing drive power and communicating a measurement signal, is a 4-20 mA industrial loop.

If advantageous, the measurement circuitry 33 can be connected to means for storing energy, such as a capacitor or battery 38, enabling storage of surplus energy during periods of low power consumption

The barrier 3 comprises fuses 4, 5 on each line 1, 2, a voltage protection circuit 6 between the lines, and resistors 7, 8 connected on each line 1, 2 after the voltage protection circuit 6. During operation, the fuses 4, 5 protect the area 36 from excessive input power/current, the circuit 6 protects the area 36 from excessive voltages, and the resistors 7, 8 protects the area 36 from excessive output current/power. In order to comply with safety regulations for intrinsically safe areas the voltage protection circuit has to be redundant. For example, in order to comply with intrinsically safe category “ia” (e.g. according to EN50020), three parallel voltage protection circuits 6 are required. The circuit 6 is also referred to as a voltage shunt, and the voltage between the two lines USHUNT as the shunt voltage.

The voltage protection circuit 6 in FIG. 1 can, according to an embodiment of the invention, comprise a circuit 10 as shown in FIG. 2a. The illustrated circuit 10 comprises an N-type field effect transistor 11 and a zener diode 12 having its cathode connected to the drain of the transistor, and its anode connected to the gate of the transistor. Further, a resistor 13 is connected between the source and gate of the transistor.

During operation, the diode 12 will thus act as a feedback control of the transistor 11, ensuring that the voltage u_{DS} over the circuit is kept close to, but not exceeding, the threshold voltage or regulator voltage of the zener diode 12 plus the voltage over the resistor 13. The resistor is chosen such that this voltage, resulting from the threshold current i_{SH} of the diode, typically in the order of μA, is below the gate threshold of the transistor 11. As soon as the voltage over the circuit exceeds a certain level, the voltage over the diode will exceed the threshold voltage, and the current iSH through the diode will increase rapidly. This will cause the voltage over the resistor, and thus the gate voltage, to increase, and cause the transistor to open. The transistor will thus handle the energy dissipation resulting from such an over voltage.

Of course, the transistor can instead be a P-type FET, in which case the zener diode should be connected as indicated in FIG. 2b, showing an alternative circuit 10′.

The transistor does not need to be a FET, but any type of transistor can be used, such as an NPN or PNP bipolar transistor, in which case the diode is connected between the base and the collector with suitable polarity. The function of the circuit would be similar, although the bipolar transistor is current controlled instead of voltage controlled.

As the circuit 10, 10′ has similar characteristics as a regulator diode, the terminal 25 where current iSH enters the circuit during operation will be referred to as a cathode, and the terminal 26 where current exits the circuit during operation will be referred to as an anode. It should be noted that the polarity of the circuit 10, 10′ coincides with that of the voltage regulator component 12.

The voltage regulator component, which has been illustrated by a zener diode 12, can be replaced with any other diode having the desired threshold characteristics, such as an avalanche diode, or a more complex component, such as an integrated circuit.

The basic principle of the circuit in FIGS. 2a and 2b is to bypass the greater part of the current flowing through the circuit via the transistor. This enables the use of a relatively low power diode, e.g. in the order of 0.1 Watt, typically offering significantly better voltage regulation than more powerful diodes. The characteristics of the diode are then transferred to the entire circuit.

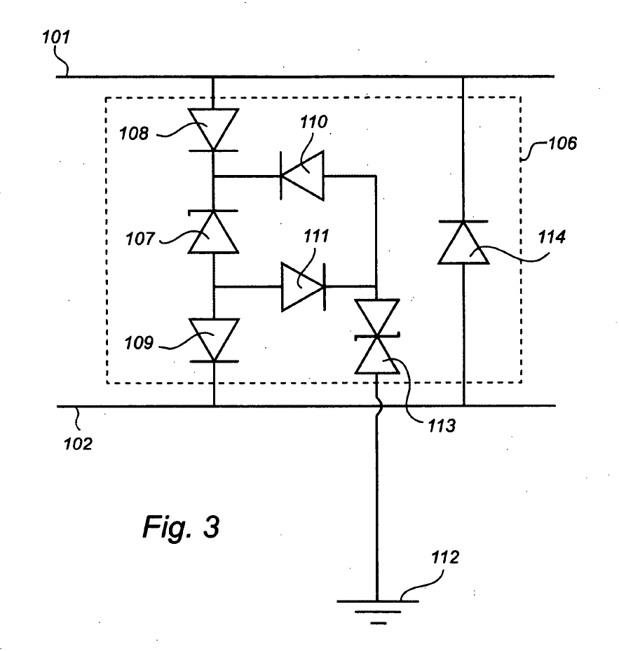

A voltage protection circuit 106 according to a further embodiment of the invention is shown in FIG. 3, connected between the lines 101, 102 of a two-wire sensor. A voltage regulator component 107, such as a zener diode, acts as a voltage protection between the lines 101, 102. A first diode 108 is connected with its cathode to the cathode of the voltage regulator component (here the cathode of the zener diode) and its anode to the first line. A second diode 109 is connected with its anode to the anode of the voltage regulator component (here the anode of the zener diode) and its anode to the second line. The cathode of a third diode 110 is connected to the cathode of the voltage regulator component, and the anode of a fourth diode 111 is connected to the anode of the voltage regulator component. The anode of the third diode and the cathode of the fourth diode are connected to ground 112 via a pair of zener diodes 113 connected in series cathode to cathode. A fifth 114 diode is connected with its cathode to the first line 101 and its anode to the second line 102.

By selecting the various components the circuit in FIG. 3 can be made symmetric with respect to the ground connection 112. Further, the circuit will provide a given limiting voltage not only for the voltage between the lines 101, 102, but also between each line 101, 102 and ground 112.

A voltage between the lines greater than the limiting voltage of voltage regulator component 107 will cause a current through diodes 108, 107 and 109. If the polarity of the line voltage is reversed, a current will immediately flow through diode 114.

A voltage between the first line 102 and ground 112 greater than the limiting voltage of voltage regulator component 107 will cause a current through diodes 108, 107, 111 and 113, or through diodes 113, 110, 107, 109 and 114 depending on polarity.

Finally, a voltage between the second line 102 and ground 112 greater than the limiting voltage of voltage regulator component 107 will cause a current through diodes 114, 108, 107, 111 and 113, or through diodes 113, 110, 107 and 109, again depending on polarity.

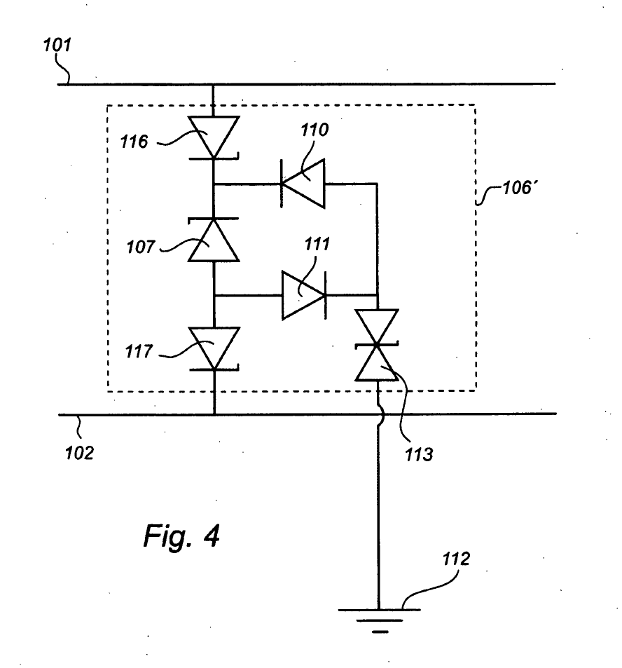

An alternative to the circuit in FIG. 3 is shown in FIG. 4, and is denoted 106′. Here, the two diodes 108 and 109 have been replaced by voltage regulator diodes (e.g. zener diodes) 116 and 117, and the fifth diode 114 has been eliminated.

Here, the voltage between the lines 101 and 102 is regulated by the limiting voltages of diodes 116, 107 and 117 (regardless of polarity). The diodes 116 and 117 preferably have the same limiting voltage as the voltage regulator component 107. The voltage between line 101 and ground 112 is now regulated by the limiting voltage of the diode combination 116, 107, 111 and 113, or 113, 110, 116 depending on polarity. The voltage between line 102 and ground 112 is now regulated by the limiting voltage of diode combination 117, 111 and 113 or 113, 110, 107 and 117, depending on polarity.

The voltage regulator component 107 in FIGS. 3 and 4 can be a voltage protection circuit as according to the first aspect of the invention, e.g. a circuit as disclosed in FIG. 2. However, it may also, as indicated above, be a zener diode or any other type of voltage regulator diode.

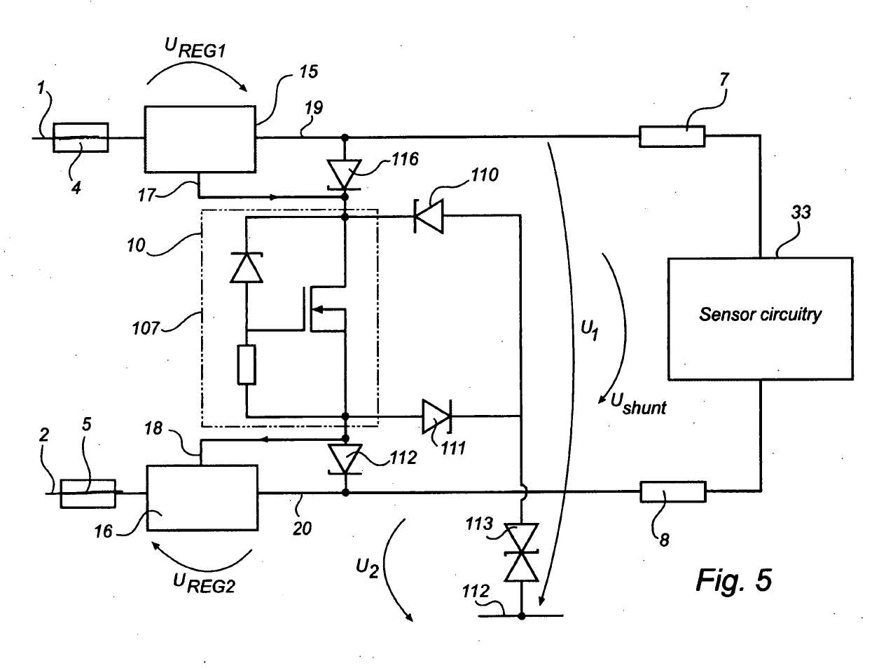

As was mentioned before, an electrical barrier is typically preceded by a voltage regulator, in order to ensure that the voltage over the shunt does not exceed the threshold voltage. FIG. 5 shows how such a regulator can be implemented without loosing the symmetry of the voltage limitation.

According to the embodiment in FIG. 5, the two-wire sensor of FIG. 1 has been provided with a voltage shunt 106 according to FIG. 4, where the voltage regulator component 107 has been substituted with a circuit 10 according to FIG. 2a. Components corresponding to the components in previous figures have been given identical reference numerals. Further, the circuit is provided with two voltage regulators 15, 16, one on each line 1, 2. Note that, as mentioned above, several identical voltage shunts may be provided in parallel between the lines 1 and 2, in order to comply with safety regulations, such as category “ia”.

In a system with a grounded supply, the output voltage of the regulators 15, 16 dependes on how the voltage shunt is connected. The barrier should ensure that the voltage between any one of the lines 1, 2 and ground does not exceed a given limit. The purpose of the regulators is to keep the current comsumption as low as possible, preferably equal to the regulating threshold current of the circuit 10.

The voltage regulators 15 and 16 are complement to each other, with regulator 15 connected in series with the positive line 1 and regulator 16 connected in series with the negative line 2.

The voltage drop—input to output—u_{REG1} and u_{REG2} generated on each voltage regulator 15, 16 is controlled by a small regulation current in adherent control inputs 17 and 18. Further, as the control input 17, 18 is connected to the regulator terminal facing the sensor (the output 19 of regulator 15 and the input 20 of regulator 16), the voltage difference between these two terminals is close to zero.

An increased control current drawn from the control terminal 17 on voltage regulator 15 will produce a proportionally increased voltage drop over the regulator 15. Operation is similar for regulator 16 but control current is conducted into control terminal 18.

Control terminals 17 and 18 on voltage regulators 15 and 16 are each connected to opposite side of the voltage protection circuit 10. As soon as the voltage U_{DS} present between the cathode and anode of voltage protection circuit 10 is above the regulation threshold, a control current essentially equal to the threshold current will be conducted from control terminal 17 through voltage protection circuit 10 into control terminal 18.

At low supply input voltage between line 1 and line 2, the voltage regulators will be saturated (left open). The reason is that there will be no control current flowing through the circuit 10, as the voltage over the circuit 10 is below the regulation threshold. Increasing the input voltage until regulation threshold of voltage protection 10 is reached will create a regulation current through the circuit 10, and thus a control current to the voltage regulators 15, 16. The voltage drop over each voltage regulator 15, 16 will from this point on increase in direct proportion to further increased supply voltage, thus keeping output voltage regulated to a voltage equal to the threshold voltage of voltage protection circuit 10.

The very low current required for regulation (order of μA) will be conducted through the voltage regulation diode 12 in circuit 10, as the voltage generated over the resistor 13 connected to the control terminal of the transistor 11 is too low to activate the transistor device. No additional current will be conducted through diodes 116 and 117, since voltage between control terminals and output on the voltage regulators is zero.

The proposed circuitry also monitors current being conducted through the voltage protection circuit 10 to ground 112, in order to automatically adjust absorbed voltage and eliminate any such current. This enables maintaining a low current consumption through circuit 10 equal to the regulation current required.

Typically, one supply pole of the power supply is bonded to ground, which introduces another ground connection in the system. A voltage difference between the different ground connections, together with voltage drops in the supply lines 1, 2, can cause a current through the voltage protection circuit 10 to ground 112. Depending on polarity of supply with respect to ground, such a current will be conducted either through diode 110 or 111 further to bidirectional diode 113 and to ground 112. This current will be added through diode 110 or removed through diode 111 to the current through circuit 10. According to this embodiment of the invention, such a change in the current through circuit 10 will reduce voltage drop over one regulator and increase voltage drop over the other. This regulation will thus rebalance the barrier with respect to the ground connection of the supply, thus removing the voltage difference and the current to ground 112. This will ensure that current consumption is kept low, within values required from regulation and for a satisfactory performace of the sensor interface.

At a certain level of voltage unbalance between supply and the circuit in FIG. 5, one voltage regulator may be saturated and unable to lower its voltage drop any more, in which case the output voltage to the sensor will decrease. Current consumption will still be kept low beyond this point as regulation still is operational.

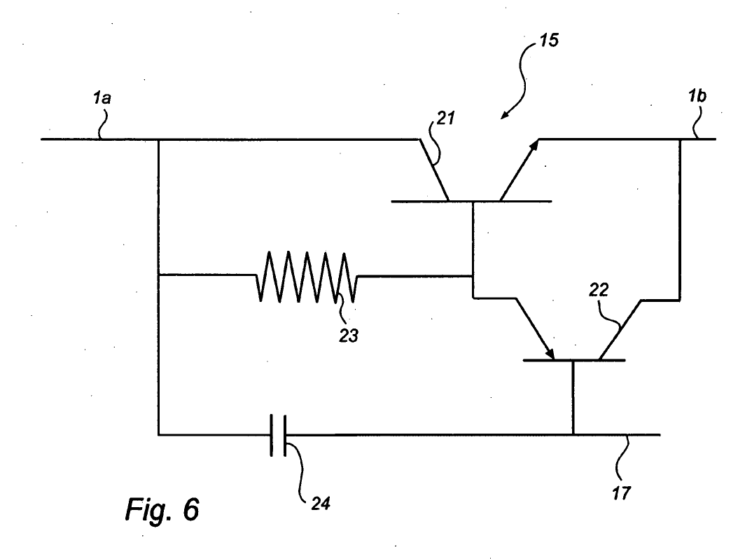

A more detailed block diagram of a specific embodiment of the regulator 15 is given in FIG. 6. Again, similar components have been given identical reference numerals as in previous figures.

The circuit in FIG. 6 comprises two bipolar transistors, an NPN transistor 21 and a PNP transistor 22. The incoming line 1a is connected to the collector of the NPN transistor 21, while its emitter is connected to the outgoing line 1b. The emitter of the PNP transistor 22 is connected to the gate of the NPN transistor 21, while its collector is connected to the outgoing line 1b. A resistor 23 is connected between the base of transistor 21 and the incoming line 1a, and a capacitor is connected between the incoming line 1a and the gate of transistor 22, which gate also acts as the control terminal 17.

The second voltage control unit 16 in FIG. 5 can be similar to the circuit shown in FIG. 6, but with the PNP and NPN transistors having switched places.

During operation, the voltage control units in FIG. 5 will ensure that the shunt voltage u_{SHUNT} over the sensor is held at a level close to the breakthrough voltage of the zener diode in the shunt circuit. Also, the control units will ensure that the shunt voltage is symmetrical around ground. As mentioned above, the voltage protection circuit 106′ will further ensure that both lines are voltage protected with respect to ground.

In the above, the invention has primarily been described with reference to a radar level gauge system. However, it should be noted that the invention is equally applicable to other types of sensor arrangements.

What is claimed is:

1. A radar level gauge using microwaves for measuring a level of a surface of a product in a container, comprising:
a microwave emitter for transmitting microwaves towards the surface and receiving microwaves reflected by the surface,
measurement circuitry arranged to determine said level based on a relation between transmitted and received microwaves,
a signal transfer medium coupled at a first end to said microwave emitter and coupled at second end to said measurement circuitry,
a two-wire interface for connecting said measurement circuitry externally of said radar level gauge, and
voltage protection circuitry connected between the two lines of the two-wire interface, said voltage protection circuitry including:
a transistor having an input, an output and a control terminal,
a voltage regulator component connected between the output and the control terminal in such a way that the regulating characteristics of the voltage regulator component determines the voltage required to open the transistor, and
a resistor connected between the control terminal and the input of the transistor.

2. The radar level gauge in claim 1, wherein the voltage regulator component is a regulator diode.

3. The radar level gauge in claim 1, wherein the voltage regulator component is an integrated circuit.

4. The radar level gauge in claim 1, wherein the transistor belongs to the group of power transistor, field effect transistor, MOSFET, and bipolar transistor.

5. The radar level gauge in claim 1, wherein said two-wire interface is arranged to provide the measurement circuit with power.

6. The radar level gauge in claim 1, wherein said two-wire interface is arranged to communicate an indication of said level.

7. A sensor for gauging a process variable, comprising:
measurement circuitry arranged to perform a measurement of said process variable and to determine a value of said process variable based on said measurement,
a two-wire interface for connecting said measurement circuitry externally of said sensor, and
voltage protection circuitry connected between the two lines of the two-wire interface, said voltage protection circuitry including:
a transistor having an input, an output and a control terminal,
a voltage regulator component connected between the output and the control terminal in such a way that the regulating characteristics of the voltage regulator component determines the voltage required to open the transistor, and
a resistor connected between the control terminal and the input of the transistor.

8. The sensor in claim 7, wherein the voltage regulator component is a regulator diode.

9. The sensor in claim 7, wherein the voltage regulator component is an integrated circuit.

10. The sensor in claim 7, wherein the transistor belongs to the group of power transistor, field effect transistor, MOSFET, and bipolar transistor.

11. The sensor in claim 7, wherein said two-wire interface is arranged to provide the measurement circuit with power.

12. The sensor in claim 7, wherein said two-wire interface is arranged to communicate a measurement signal.

13. A radar level gauge using microwaves for measuring a level of a surface of a product in a container, comprising:
a microwave emitter for transmitting microwaves towards the surface and receiving microwaves reflected by the surface,
measurement circuitry arranged to determine said level based on a relation between transmitted and received microwaves,
a signal transfer medium coupled at a first end to said microwave emitter and coupled at second end to said measurement circuitry,
a two-wire interface for connecting said measurement circuitry externally of said radar level gauge, and
voltage protection circuitry connected between the two lines of the two-wire interface, said voltage protection circuitry including:
a voltage regulator device having a cathode and an anode,
a first diode connected with its anode to the first line and its cathode to the cathode of the regulator device,
a second diode connected with its cathode to the second line and its anode to the anode of the regulator device,
a third diode connected with its cathode to the cathode of the first diode and its anode to ground,
a fourth diode connected with its anode to the anode of the second diode and its cathode to ground.

14. The radar level gauge in claim 13, wherein said voltage regulator device is a voltage regulator diode.

15. The radar level gauge in claim 13, wherein said voltage regulator device comprises:
a transistor having an input, an output and a control terminal,
a voltage regulator component connected between the output and the control terminal in such a way that the diode characteristics determines the voltage required to open the transistor, and
a resistor connected between the control terminal and the input of the transistor.

16. The radar level gauge in claim 13, wherein said first and second diodes are connected to ground via a bi-directional regulator diode.

17. The radar level gauge in claim 13, wherein said two-wire interface is arranged to provide the measurement circuit with power.

18. The radar level gauge in claim 13, wherein said two-wire interface is arranged to communicate an indication of said level.

19. A sensor for gauging a process variable, comprising:
measurement circuitry arranged to perform a measurement of said process variable and to determine a value of said process variable based on said measurement,
a two-wire interface for connecting said measurement circuitry externally of said sensor, and
voltage protection circuitry connected between the two lines of the two-wire interface, said voltage protection circuitry including:
a voltage regulator device having a cathode and an anode,
a first diode connected with its anode to the first line and its cathode to the cathode of the regulator device,
a second diode connected with its cathode to the second line and its anode to the anode of the regulator device,
a third diode connected with its cathode to the cathode of the first diode and its anode to ground,
a fourth diode connected with its anode to the anode of the second diode and its cathode to ground.

20. The sensor in claim 19, wherein said voltage regulator device is a voltage regulator diode.

21. The sensor in claim 19, wherein said voltage regulator device comprises:
a transistor having an input, an output and a control terminal,
a voltage regulator component connected between the output and the control terminal in such a way that the diode characteristics determines the voltage required to open the transistor, and
a resistor connected between the control terminal and the input of the transistor.

22. The sensor in claim 19, wherein said first and second diodes are connected to ground via a bi-directional regulator diode.

23. The sensor in claim 19, wherein said-two-wire interface is arranged to provide the measurement circuit with power.

24. The sensor in claim 19, wherein said two-wire interface is arranged to communicate a measurement signal.

25. A radar level gauge using microwaves for measuring a level of a surface of a product in a container, comprising:
a microwave emitter for transmitting microwaves towards the surface and receiving microwaves reflected by the surface,
measurement circuitry arranged to determine said level based on a relation between transmitted and received microwaves,
a signal transfer medium coupled at a first end to said microwave emitter and coupled at second end to said measurement circuitry,
a two-wire interface for connecting said measurement circuitry externally of said radar level gauge,
voltage protection circuitry connected between the two lines of the two-wire interface, said voltage protection circuitry being symmetric with respect to ground,
a first current controlled voltage regulator connected on the first line, and a second current controlled voltage regulator connected on the second line,
said voltage regulators being controlled by a regulating current flowing through the voltage barrier.

26. The radar level gauge in claim 25, wherein the voltage protection circuitry comprises:
a voltage regulator device having a cathode and an anode,
a first diode connected with its anode to the first line and its cathode to the cathode of the regulator device,
a second diode connected with its cathode to the second line and its anode to the anode of the regulator device,
a third diode connected with its cathode to the cathode of the first diode and its anode to ground,
a fourth diode connected with its anode to the anode of the second diode and its cathode to ground.

27. The radar level gauge in claim 26, wherein the voltage regulator device comprises:
a transistor having an input, an output and a control terminal,
a voltage regulator component connected between the output and the control terminal in such a way that the diode characteristics determines the voltage required to open the transistor, and
a resistor connected between the control terminal and the input of the transistor.

28. The radar level gauge in claim 27, where said regulating current is a threshold current through the voltage regulator component.

29. The radar level gauge in claim 25, wherein said two-wire interface is arranged to provide the measurement circuit with power.

30. The radar level gauge in claim 25, wherein said two-wire interface is arranged to communicate an indication of said level.

31. A sensor for gauging a process variable, comprising:
measurement circuitry arranged to perform a measurement of said process variable and to determine a value of said process variable based on said measurement,
a two-wire interface for connecting said measurement circuitry externally of said sensor,
voltage protection circuitry connected between the two lines of the two-wire interface, said voltage protection circuitry being symmetric with respect to ground,
a first current controlled voltage regulator connected on the first line, and a second current controlled voltage regulator connected on the second line,
said voltage regulators being controlled by a regulating current flowing through the voltage barrier, thereby ensuring that the circuit configuration.

32. The sensor in claim 31, wherein the voltage protection circuitry comprises:
a voltage regulator device having a cathode and an anode,
a first diode connected with its anode to the first line and its cathode to the cathode of the regulator device,
a second diode connected with its cathode to the second line and its anode to the anode of the regulator device,
a third diode connected with its cathode to the cathode of the first diode and its anode to ground,
a fourth diode connected with its anode to the anode of the second diode and its cathode to ground.

33. The sensor in claim 32, wherein the voltage regulator device comprises:
a transistor having an input, an output and a control terminal,
a voltage regulator component connected between the output and the control terminal in such a way that the diode characteristics determines the voltage required to open the transistor, and
a resistor connected between the control terminal and the input of the transistor.

34. The sensor in claim 32, where said regulating current is a threshold current through the voltage regulator component.

35. The sensor in claim 32, wherein said two-wire interface is arranged to provide the measurement circuit with power.

36. The sensor in claim 32, wherein said two-wire interface is arranged to communicate a measurement signal.
